(19) United States
(12) Patent Application Publication
(10) Pub. No.: US 2004/0192222 A1
(43) Pub. Date: Sep. 30, 2004

(54) System and method for semi-simultaneously coupling an antenna to transceivers

(75) Inventors: Ari Vaisanen, Ruutana (FI); Pekko Orava, Tampere (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation, Espoo (FI)

(21) Appl. No.: 10/402,249

(22) Filed: Mar. 26, 2003

(51) Int. Cl. H04B 1/38; H04B 1/44

(52) U.S. Cl. 455/78; 455/73

(57) ABSTRACT

An antenna coupling system and method for operating same are adapted to operate a common antenna with a first transceiver and a second transceiver. The first transceiver provides a quality signal relating to a received radio frequency (RF) signal, which is supplied to the antenna coupling system. The antenna coupling system is operable with at least one low loss mode and at least one high loss mode in accordance with the provided quality signal as desired. The antenna coupling system couples selectively one of the first and the second transceivers to the common antenna in the at least one low loss mode such that in the meantime the other one is disconnected from the common antenna. The antenna coupling system couples simultaneously the first transceiver and the second transceiver to the common antenna in the at least one high loss mode.

### BACKGROUND OF THE INVENTION

1. Technical Field

The present invention relates to an antenna coupling system which controls the operation of at least two different transceivers with a common antenna. Particularly, the present invention relates to an antenna coupling system for operating a WLAN transceiver and a Bluetooth transceiver performing radio frequency (RF) data transceiving with a common RF antenna.

2. Discussion of Related Art

Wireless communication techniques are still under development and are subject to an enormous rise in application in mobile communication terminals. Different wireless communication techniques compete but also amplify each other in their application in mobile communication terminals. The extension of wireless communication techniques based on different transmission methods, offering consequently different advantages but also having drawbacks result in that the state of the art terminals allowing wireless communications have implemented two or even several wireless communication modules each supporting one or more wireless communication techniques. Users of such mobile communication terminals have the choice to operate those wireless communications which seems to be the appropriate choice.

Wireless communication techniques are typically used in terminals having a high mobility such that the terminals are employable and accepted by the user. Mobility of terminals offering wireless communications to the user depends highly, beneath others, on their dimensions and their weights. The bigger the dimensions or the heavier the weight the smaller the acceptance is by potential customers. Dimension and weight are key issues of mobile terminals.

The rise in application of wireless communication techniques started with public land mobile networks (PLMN) which allow to operate cellular phones. Several different standards for public land mobile networks (PLMN) have been established in the last years, such as Global System for Mobile communication (GSM), Global Digital System for mobile communication (DCS) and the coming Universal Mobile Telecommunication System (UMTS) to name just a few of the numerous standards employed worldwide. Wireless communication techniques got also applicable to local (in-house) wireless communications. For local wireless communications, standards like wireless local area networks (WLAN) and Bluetooth have been developed and coexist today since WLAN offers wireless communications with high data rates within a local area of up to a few hundreds of square meters and Bluetooth was primarily developed to replace local electric connection lines between different electronic terminals within a local area of a few square meters.

Multi-modal communication terminals implementing different wireless communication techniques are state of the art. Today's enhanced cellular phones comprise beyond a transceiver for one or more public land mobile networks (PLMN) also additional Bluetooth transceivers and/or WLAN transceivers. The implementation of the different transceivers is often realized by implementing separately complete transceiver systems comprising the transceiver and one or more corresponding antennas. A separate implementation of transceiver systems provides the best physical properties in view of receiving capability and transmitting capability. But the separate implementation requires space, increases weight, increases production and testing expenses. Particularly, antenna structures are space demanding. To overcome such disadvantages several developments have been made.

Documents EP 0 923 158 and EP 0 938 158 shall be referenced as background as those documents disclose multi-resonant frequency antennas employable for Global System for Mobile communication (GSM) communication on the different GSM frequency bands which are situated at 900 MHz, 1.8 GHz and eventually 1.9 GHz when taking Global Digital System for mobile communication (DCS) into account.

When referring to local wireless communication techniques WLAN and Bluetooth similar developments have been made to offer multi-modal transceiver systems comprising WLAN and Bluetooth transceivers and antennas coupled via an antenna coupling system thereto. Traditionally, a WLAN transceiver is provided with two antennas forming a diversity antenna system for improved receiving characteristics. Bluetooth transceivers are conventionally operated with a single antenna. The combination of a WLAN and Bluetooth transceiver within a portable terminal would require three antennas (two antennas for WLAN, one antenna for Bluetooth) in accordance with the aforementioned state of the art teaching. Siliconwave-Intersil for example provides an alternative technique which uses a 3-to-2 switching matrix to couple a WLAN receiver (RX), a WLAN transmitter (TX) and a Bluetooth transceiver (RX/TX) to two antennas. Similarly, Mobilian solves the same problem by dedicating a first antenna to a WLAN receiver and Bluetooth receiver and a second antenna to a WLAN transmitter and a Bluetooth transmitter. Those implementations still lack on the same drawback that two or possibly even three antennas have to be implemented into a small form factor of portable terminals.

Particularly, the design of interface cards according to the personal computer memory card international association (PCMCIA) standard, PCCARD standard or related interface card standards used preferably in portable terminals like mobile computers, personal digital assistant terminals (PDA) or the like puts high demands on size, shape, power consumption, mechanical durability and costs so that the implementation of complete separated transceiver systems is not feasible and sensible, respectively.

### DISCLOSURE OF INVENTION

A first object of the invention is to provide an antenna coupling system which allows to operate a single antenna with two RF transceivers, in particular operating according to different RF communication standards. The common usage of the antenna in conjunction with two RF transceivers reduces the dimensions required to implement the RF interface comprising antenna and transceivers. Moreover, the antenna coupling system is further designed to allow simultaneous operation of the two RF transceivers in a high loss mode and single operation of one of the RF transceivers in a low loss mode.

The simultaneous operation in a high loss mode ensures that no data loss occurs, whereas a low loss mode ensures that in case high data rates are required or receiving characteristics are bad the RF data communication is further operable at justifiable conditions.

A second object of the invention is to provide a method for controlling the antenna coupling system, which may be operated by a dedicated controller which in particular also controls the operation of the transceivers coupled to the antenna coupling system.

A third object of the invention is to provide a controller capable of operating the antenna coupling system.

According to an aspect of the invention, an antenna coupling system for operating a common antenna with a first transceiver and a second transceiver is provided. The first transceiver provides a quality signal relating to a received radio frequency (RF) signal, which is supplied to the antenna coupling system. The antenna coupling system is operable with at least a low loss mode and a high loss mode in accordance with the provided quality signal which allow the selection of one of the modes. A quality signal (RSSI) which indicates a low signal quality may cause a selection of the low loss mode, whereas a quality signal (RSSI) which indicates a high signal quality may cause a selection of the high loss mode. The antenna coupling system couples selectively one of the first and the second transceivers to the common antenna in the low loss mode such that the other one is disconnected from the common antenna in the meantime. In particular, the antenna coupling system at least allows to couple selectively the first transceiver to the common antenna wherein in the meantime the second transceiver is de-coupled from the common antenna in the low loss mode. The antenna coupling system couples simultaneously the first transceiver and the second transceiver to the common antenna in the high loss mode.

According to an embodiment of the invention, the system further comprises a first switch, a second switch and a radio frequency signal divider. The first switch is connected to the common antenna, the second switch and the signal divider. The second switch is connected to the first switch, the signal divider and the first transceiver. The signal divider is connected to the first switch, the second switch and the second transceiver. According to an embodiment of the invention, the system moreover comprises a third switch and the transceiver consists of a transmitting unit and a receiving unit. The second switch is connected to the receiving unit of the first transceiver. The third switch is interposed between the common antenna and the signal divider to connect the transmitting unit of the first transceiver. Moreover, the third switch may be interposed between the first switch and the signal divider, wherein the third switch is connected to the first switch, the signal divider and the transmitting unit of the first transceiver.

According to an embodiment of the invention, the high loss mode with which the antenna coupling system is operable further comprises a first transceiver/second transceiver receiving mode (mode 1) and a first transceiver receiving/second transceiver transmitting mode (mode 2). The antenna coupling system couples simultaneously the first transceiver and the second transceiver to the common antenna to enable simultaneous receiving operated by the first transceiver and the second transceiver in the first transceiver/second transceiver receiving mode. The antenna coupling system couples simultaneously the first transceiver and the second transceiver to the common antenna to enable simultaneous receiving operated by the first transceiver and transmitting operated by the second transceiver in the first transceiver receiving/second transceiver transmitting mode. Therefore in the modes 1 and 2, a first and a second RF signal paths are provided by the antenna coupling system. The first RF signal path connects the common antenna and the receiving unit for receiving through the first switch, the third switch, the RF signal divider and the second switch. The second RF signal path connects the common antenna and the second transceiver for receiving and transmitting, respectively, through the first switch, the third switch and the RF signal divider.

Moreover, the low loss mode with which the antenna coupling system is operable comprises a first transceiver receiving mode (mode 3), a first transceiver transmitting mode (mode 4), a second transceiver receiving mode (mode 5), a second transceiver transmitting mode (mode 6). The antenna system couples exclusively the first transceiver to the antenna to allow exclusive receiving operated by the first transceiver in the first transceiver receiving mode and exclusive transmitting operated by the first transceiver in the first transceiver transmitting mode. The antenna system couples exclusively the second transceiver to the antenna to allow exclusive receiving operated by the second transceiver in the second transceiver receiving mode and exclusive transmitting operated by the second transceiver in the second transceiver transmitting mode.

In the mode 3, a RF signal path connects the common antenna and the receiving unit of the first transceiver for receiving through the first switch and the second switch. In parallel, the second transceiver is disconnected completely from the common antenna. In the mode 4, a RF signal path connects the common antenna and the transmitting unit of the first transceiver for transmitting through the first switch and the third switch. In parallel the second transceiver is disconnected completely from the common antenna. In the mode 5 and mode 6, a RF signal path connects the common antenna and the second transceiver for receiving and transmitting, respectively, through the first switch, the third switch and the RF signal divider. In parallel, the first transceiver is disconnected completely from the common antenna.

According to an embodiment of the invention, the system further comprises a testing interface and a fourth switch for testing purposes of either the first transceiver or the second transceiver. The antenna coupling system connects selectively the testing interface to the receiving unit of the first transceiver in a first testing mode, to the transmitting unit of the first transceiver in the second testing mode and to the second transceiver in a third testing mode. The common antenna is disconnected completely from the antenna coupling system. Particularity, the testing interface is coupled to the receiving unit of the first transceiver via the fourth switch, the first switch and the second switch in the first testing mode, the testing interface is coupled to the transmitting unit of the first transceiver via the fourth switch, the first switch and the third switch in the second testing mode and the testing interface is coupled to the second transceiver via the fourth switch, the first switch and the third switch and the RF signal divider in the third testing mode. More particularly, the RF signal divider is operable with a normal power divider mode and a direct power feed through mode.

According to an embodiment of the invention, the first transceiver and the second transceiver operate in the same frequency range, i.e. common frequency band, for transceiving RF signals. Particularly, the first transceiver is a WLAN transceiver whereas the second transceiver is a Bluetooth transceiver which may both share the ISM (industrial, scientific and medical) frequency band.

According to an embodiment of the invention, the first transceiver operates in a certain sub-range of the common frequency band for receiving in the second mode (mode 2) and the second transceiver operates in at least another sub-range of the common frequency band for transmitting in said second mode (mode 2). In particular, a WLAN transceiver according to the 802.11b and 802.11g as well as a Bluetooth transceiver both operate on the 2.4 GHz ISM frequency band such that a coexistence in view of simultaneous transmitting and receiving is problematic. However, WLAN transceivers as well as Bluetooth transceivers operate on physical channels for transceiving which capture certain sub-ranges of the 2.4 GHz ISM frequency band. The Bluetooth 1.2 adaptive frequency hopping (AFH) standard allows to ensure that in case of coexisting WLAN and Bluetooth transceivers the operating channels thereof do not overlap which may otherwise cause interference.

According to an aspect of the invention, a method for operating an antenna coupling system is provided which allows to control the operation of a common antenna serving selectively or simultaneously as a common antenna for a first transceiver and a second transceiver, respectively. A quality signal (RSSI) is received from the first transceiver which determines the quality signal (RSSI) from a received radio frequency signal. One of the operation modes comprising at least a low loss mode and a high loss mode is selected in accordance with the quality signal (RSSI) and the antenna coupling system is operated with the selected operation mode. A quality signal (RSSI) which indicates a low signal quality may cause a selecting of the low loss mode, whereas a quality signal (RSSI) which indicates a high signal quality may cause a selecting of the high loss mode. In case of the low loss mode one of the first and the second transceivers is connected selectively to the common antenna whereas the second transceiver is disconnected completely therefrom in the meantime. In particular, the antenna coupling system is operated in the low loss mode to at least couple selectively the first transceiver to the common antenna wherein in the meantime the second transceiver is de-coupled from the common antenna. In case of the high loss mode the first transceiver and the second transceiver are coupled simultaneously to the common antenna.

According to an embodiment of the invention, the selection of the operation mode comprises a comparison of the quality signal (RSSI) provided by the first transceiver with a pre-defined threshold value. In case the quality signal is low, the low loss operation mode is selected, otherwise the high loss operation mode is selected.

According to an embodiment of the invention, the antenna coupling system comprises a first switch, a second switch and a radio frequency (RF) signal divider. The operation of the antenna coupling system with the low loss mode comprises an operating of the switches to establish a signal path between the common antenna and one of the first and the second transceivers. The other transceiver is disconnected completely from the common antenna in the meantime when the low loss mode is operated. In particular, the operation of the antenna coupling system with the low loss mode comprises at least an operating of the switches to establish a signal path between the common antenna and the first transceiver. The coupling of the common antenna and the first transceiver is obtained in the low loss mode by routing RF signals supplied by the common antenna through the first switch and the second switch.

The operation of the antenna coupling system with the high loss mode comprises operating of the switches to establish a first signal path between the common antenna and the first transceiver and to establish simultaneously a second signal path between the common antenna and the second transceiver. The coupling of the common antenna and the first transceiver is obtained in the high loss mode by routing RF signals supplied by the common antenna through the first switch, the RF signal divider and the second switch. Simultaneously, the coupling of the common antenna and the second transceiver is obtained in the high loss mode by routing RF signals supplied by the common antenna through the first switch and the RF signal divider.

According to an embodiment of the invention, the antenna coupling system further comprises a third switch and the first transceiver includes a transmitting unit and a receiving unit. The high loss mode further includes a first mode (mode 1) and a second mode (mode 2) and the low loss mode moreover includes a third mode (mode 3), a fourth mode (mode 4), a fifth mode (mode 5), a sixth mode (mode 6).

The operating of the antenna coupling system with the first mode (mode 1) and the second mode (mode 2) comprises an operating of the switches to establish a first signal path between the common antenna and the receiving unit of the first transceiver for receiving and to establish simultaneously a second signal path between the common antenna and the second transceiver for receiving and transmitting, respectively. In the first mode (mode 1) and the second mode (mode 2), RF signals provided by the common antenna are routed from the common antenna through the first switch, the third switch, the RF signal divider and the second switch to the receiving unit of the first transceiver and RF signals provided by the common antenna are routed simultaneously through the first switch, the third switch and the RF signal divider to the second transceiver.

The operating of the antenna coupling system with the third mode (mode 3) comprises an operating of the switches to establish a signal path between the common antenna and the receiving unit of the first transceiver for receiving. The second transceiver is completely disconnected from the common antenna. The signal path in the third mode (mode 3) is routed through the first switch and the second switch.

The operating of the antenna coupling system with the fourth mode (mode 4) comprises an operating of the switches to establish a signal path between the common antenna and the transmitting unit of the first transceiver for transmitting The second transceiver is completely disconnected from the common antenna. The signal path in the fourth mode (mode 4) is routed through the first switch and the third switch.

The operating of the antenna coupling system with the fifth mode (mode 5) and the sixth mode (mode 6) comprises an operating the switches to establish a signal path between the common antenna and the second transceiver for receiving and transmitting, respectively. The first transceiver completely is disconnected from the common antenna. The signal path in the fifth mode (mode 5) and the sixth mode (mode 6), respectively, is routed through the first switch, the third switch and the RF signal divider.

According to an embodiment of the invention, the antenna coupling system is operable with testing modes for which a testing interface and a fourth switch are comprised. The operating of the antenna coupling system with a first testing mode comprises an operating of the switches to establish a signal path between the testing interface and the receiving unit of the first transceiver. The operating of the antenna coupling system with a second testing mode comprises an operating of the switches to establish a signal path between the testing interface and the transmitting unit of the first transceiver. And the operating of the antenna coupling system with a third testing mode comprises an operating of the switches to establish a signal path between the testing interface and the second transceiver. The common antenna is completely disconnected the antenna coupling system in the testing modes by operating of the fourth switch.

According to an embodiment of the invention, the first transceiver and the second transceiver operate in the same frequency range, i.e. common frequency band, for transceiving RF signals. Particularly, the first transceiver is a WLAN transceiver whereas the second transceiver is a Bluetooth transceiver which may both share the ISM (industrial, scientific and medical) frequency band.

According to an embodiment of the invention, the first transceiver operates in a certain sub-range of the common frequency band for receiving in the second mode (mode 2) and the second transceiver operates in at least another sub-range of the common frequency band for transmitting in said second mode (mode 2). In particular, a WLAN transceiver according to the 802.11b and 802.11g as well as a Bluetooth transceiver both operate on the 2.4 GHz ISM frequency band such that a coexistence in view of simultaneous transmitting and receiving is problematic. However, WLAN transceivers as well as Bluetooth transceivers operate on physical channels for transceiving which capture certain sub-ranges of the 2.4 GHz ISM frequency band.

The Bluetooth 1.2 adaptive frequency hopping (AFH) standard allows to ensure that in case of coexisting WLAN and Bluetooth transceivers the operating channels thereof do not overlap which may otherwise cause interference.

According to an aspect of the invention, a controller for an antenna coupling system for operating a common antenna with a first transceiver and a second transceiver is provided. Particularly, the controller is capable to control an antenna coupling system according to an embodiment of the present invention. More particularly, the controller is capable to operate a method for controlling the antenna coupling system according to an embodiment of the invention. The controller receives a quality signal (RSSI) from the said first transceiver, wherein the first transceiver determines the quality signal (RSSI) from a received radio frequency signal. The controller further generates at least one control signal to be fed to the antenna coupling system. The at least one control signal is generated on the basis of the supplied quality signal (RSSI) and allows to operate the antenna coupling system with at least a low loss mode and a high loss mode. In the low loss mode, the antenna coupling system connects selectively one of the first and the second transceivers to the common antenna, whereas the other transceiver is completely disconnected from the common antenna. At least, the antenna coupling system is able to couple selectively the first transceiver to the common antenna and in the meantime to de-couple the second transceiver from the common antenna in the low loss mode. In the high loss mode, the antenna coupling system connects simultaneously the first transceiver to the common antenna and the second transceiver to the common antenna.

According to an embodiment of the invention, the antenna coupling system which is to be controlled by the controller couples the common antenna with the first transceiver which includes a transmitting unit and a receiving unit and the second transceiver. Moreover, the controller generates at least one control signal such that the antenna coupling system is operable with at least the high loss mode which further includes a first mode (mode 1) and a second mode (mode 2) and the low loss mode which furthermore includes a third mode (mode 3), a fourth mode (mode 4), a fifth mode (mode 5), a sixth mode (mode 6).

The controller is adapted to generate the at least one control signal such that the antenna coupling system couples simultaneously the receiving unit of the first transceiver and said second transceiver to the common antenna for simultaneous receiving by said receiving unit of the first transceiver and the second transceiver in said first mode (mode 1) and for simultaneous receiving by the receiving unit of the first transceiver and simultaneous transmitting by the second transceiver in the second mode (mode 2).

The controller is adapted to generate the at least one control signal such that the antenna coupling system couples exclusively the first transceiver to the common antenna for exclusive receiving by the receiving unit of the first transceiver in the third mode (mode 3) and for exclusive transmitting by the first transmitting unit of the first transceiver in the fourth mode (mode 4).

The controller is adapted to generate the at least one control signal such that the antenna coupling system couples exclusively said second transceiver to the common antenna for exclusive receiving by the second transceiver in the fifth mode (mode 5) and for exclusive transmitting by the second transceiver (300) in the sixth mode (mode 6).

According to an embodiment of the invention, the antenna coupling system controlled by the controller according to an embodiment of the invention is an antenna coupling system according to one of the aforementioned embodiments of the invention.

According to an embodiment of the invention, the first transceiver and the second transceiver operate in the same frequency range, i.e. common frequency band, for transceiving RF signals. Particularly, the first transceiver is a WLAN transceiver whereas the second transceiver is a Bluetooth transceiver which may both share the ISM (industrial, scientific and medical) frequency band.

According to an embodiment of the invention, the first transceiver operates in a certain sub-range of the common frequency band for receiving in the second mode (mode 2) and the second transceiver operates in at least another sub-range of the common frequency band for transmitting in said second mode (mode 2). In particular, a WLAN transceiver according to the 802.11b and 802.11g as well as a Bluetooth transceiver both operate on the 2.4 GHz ISM frequency band such that a coexistence in view of simultaneous transmitting and receiving is problematic. However, WLAN transceivers as well as Bluetooth transceivers operate on physical channels for transceiving which capture certain sub-ranges of the 2.4 GHz ISM frequency band. The Bluetooth 1.2 adaptive frequency hopping (AFH) standard allows to ensure that in case of coexisting WLAN and Bluetooth transceivers the operating channels thereof do not overlap which may otherwise cause interference.

According to an embodiment of the invention, the controller is adapted to control the operation of the first and the second transceivers and the operation of the antenna coupling system simultaneously to ensure a suitable overall operation of the total system comprising the common antenna, the first and second transceivers and the antenna coupling system which selectively and/or simultaneously connects the common antenna to the both transceivers.

According to an aspect of the invention, a software tool for operating an antenna coupling system is provided. The software tool comprises program portions for carrying out the operations of the aforementioned methods when the software tool is implemented in a computer program and/or executed.

According to an aspect of the invention, there is provided a computer program product for operating an antenna coupling system. The computer program comprises program code portions directly loadable into a local memory of a microprocessor based component, a processing device, a terminal device, a mobile communication terminal device or a networked device for carrying out the operations of the aforementioned methods when the program is executed on thereon.

According to an aspect of the invention, a computer program product for operating an antenna coupling system is provided which comprises program code portions stored on a computer readable medium for carrying out the aforementioned methods when the program product is executed on a microprocessor based component, a processing device, a terminal device, a mobile communication terminal device or a networked device.

According to an aspect of the invention a computer data signal is provided which is embodied in a carrier wave and represents instructions which when executed by a processor cause the operations of anyone of the aforementioned methods to be carried out. Thereby Internet applications of the invention are covered.

### BRIEF DESCRIPTION OF THE DRAWING

The accompanying drawings are included to provide a further understanding of the invention and are incorporated in and constitute a part of this specification. The drawings illustrate embodiments of the present invention and together with the description serve to explain the principles of the invention. In the drawings,

FIG. 1 shows a first antenna coupling system comprising an antenna, a first transceiver, a second transceiver and an antenna coupling circuit according to an embodiment of the invention;

FIG. 2a shows a table illustrating operation modes of an antenna coupling circuit according to an embodiment of the invention;

FIG. 2b shows a second antenna coupling system comprising an antenna, a first transceiver, a second transceiver and an antenna coupling circuit according to an embodiment of the invention; and

FIG. 3 shows a third antenna coupling system comprising an antenna, a WLAN transceiver, a Bluetooth transceiver, a PTA controller and an antenna coupling circuit according to an embodiment of the invention.

Reference will be made in detail to the embodiments of the invention examples of which are illustrated in the accompanying drawings. Wherever possible the same reference numbers are used in the drawings and the description to refer to the same or like parts.

### BEST MODE FOR CARRYING OUT THE INVENTION

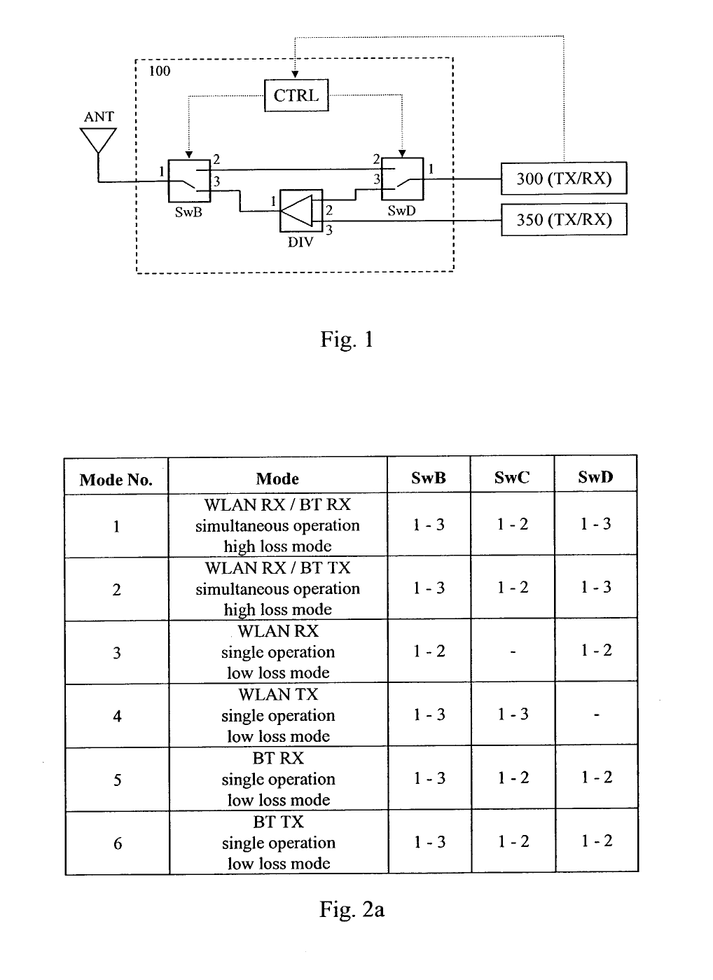

FIG. 1 shows a first antenna coupling system in accordance with the invention. The antenna coupling system comprises an antenna ANT, an antenna coupling circuit 100 according to the invention which controllably couples a first transceiver 300 and a second transceiver 350 to the antenna ANT. The antenna Ant is designed to be operable with the first transceiver 300 and the second transceiver 350 for transceiving, i.e. receiving and transmitting radio frequency signals in accordance with both the first transceiver 300 and the second transceiver 350.

The embodiment of the antenna coupling circuit shown in FIG. 1 which controllably couples a first transceiver 300 and a second transceiver 350 to the antenna ANT allows to operate at least two operation modes which will be designated in the following low loss mode and high loss mode. The low loss mode is distinguished by an exclusive operation of either the first transceiver 300 or the second transceiver 350 with the antenna ANT, whereas the high loss mode is distinguished by a simultaneous operation of both the first transceiver 300 or the second transceiver 350 with the antenna ANT. The switching between the aforementioned two operation modes, namely low loss mode and high loss mode, is caused by evaluating a quality signal (RSSI) provided by the first transceiver 300.

The quality signal (RSSI) reflects the signal quality of radio frequency signal received by the first transceiver 300 and will be designated also as received signal strength indicator (RSSI). The received signal strength indicator (RSSI) represents a measure and quantity reflecting the strength of the useful radio signal above the radio frequency signal background noise. More precisely, the received signal strength indicator (RSSI) represents an indication signal which relates to the an signal power level. The determination of the received signal strength indicator (RSSI) may be based on a measurement of a power level of the received radio frequency signals, a determination of a signal-to-noise ratio (SNR) of the received radio frequency signals or may be based on an analogous determination method. The power level and the signal-to-noise ratio should be obtained within a frequency range of interest, i.e. the frequency range or operation frequencies of the first transceiver 300. The radio frequency signals which are received by a transceiver, such as the first transceiver, have to show a sufficient signal-to-noise ratio (SNR) or the received signal strength indicator (RSSI) have to show a sufficient value such that an analyzing and evaluating of the received radio frequency signals lead to useful analyzing and evaluating results. The evaluation of the received signal strength indicator (RSSI) may be performed by comparing the received signal strength indicator (RSSI) with a pre-defined threshold value, such that in case the received signal strength indicator (RSSI) is smaller than the pre-defined threshold value the operation mode of the antenna coupling circuit is switched to the low loss mode whereas in case the received signal strength indicator (RSSI) is greater than the pre-defined threshold value the operation mode of the antenna coupling circuit is switched to the high loss mode.

It shall be assumed that the first and the second transceiver are operated in a receiving mode, that means the first and second transceiver are prepared to receive radio frequency signals from the antenna ANT, analyze the received RF signals in order to determine whether any RF signals received by the antenna ANT are dedicated for either the first transceiver and the second transceiver and/or to decode the received RF signals in correspondence to the receiving operation of the transceivers. Further, it shall be assumed that the antenna coupling circuit 100 is operated in the high loss mode. The RF signals received by the antenna ANT are provided by the antenna coupling circuit 100 to both the first transceiver 300 and the second transceiver 350, that means both transceivers 300 and 350 are able to receive RF signals provided by the antenna coupling circuit and process the RF signals correspondingly to their transceiving operation. Now, it shall be assumed that the antenna coupling circuit 100 is operated in the low loss mode. The RF signals received by the antenna ANT are provided by the antenna coupling circuit 100 to only the first transceiver 300, whereas the second transceiver 350 is disconnected in order to prevent unavoidable 3 dB minimum signal attenuation in RF signal divider of the RF signals. That means, only the first transceiver 300 is able to receive RF signals provided by the antenna coupling circuit 100 and to process the RF signals correspondingly to its transceiving operation.

The designations high loss mode in contrast to low loss mode origins from the fact that the providing of RF signals received from the antenna ANT by the antenna coupling circuit 100 implies an unavoidable degradation of the RF signals which are received originally by the antenna ANT.

In detail, the antenna coupling circuit 100 according to an embodiment of the invention shown in FIG. 1 comprises a first switch SwB, a second switch SwD and a radio frequency signal divider DIV. Each of the first and second switches have three terminal ports, wherein either port 1 and port 2 or port 1 and port 3 are connected through whereas simultaneously port 3 and port 2 are disconnected, respectively. The RF signal divider DIV receives RF signals at port 1 and acts as a passive power divider by providing the received RF signals on port 1 at port 2 and port 3. The dividing of the original supplied RF signal on port 1 at the ports 2 and 3 implies an unavoidable degradation of the provided RF signals resulting in a lower signal-to-noise ratio (SNR). In detail, the antenna ANT is coupled to port 1 of the switch SwB. The switch SwB allows to feed the RF signal supplied to port 1 to either port 2 or port 3. Port 2 of the switch SwB is connected to port 2 of the switch SwD whereas port 3 of the switch SwB is connected to port 1 of the RF signal divider DIV. In turn, the RF signal divider DIV is connected via port 2 to port 3 of the switch SwD and is coupled via port 3 to the second transceiver 350. As aforementioned, the switch SwD is connected via port 2 to port 2 of the switch SwB and via port 3 to port 2 of the RF signal divider DIV. Finally, the switch SwD is coupled via port 1 to the first transceiver 300. The both switches SwB and SwD serve to establish a bypass connection which allows to bypass RF signals received and provided by the antenna ANT directly to the first transceiver 300. Alternatively, the RF signal divider DIV serve to supply RF signals received and provided by the antenna ANT to both the first transceiver 300 and the second transceiver 350. The switches SwB and SwD may be semiconductor switches able to handle the RF signals which have frequencies corresponding to the frequency properties of the transceivers 300 and 350. Additionally, the switches SwB and SwD have two switching states such that a single switch control line for supplying a switch control signal to each of the switches SwB and SwD is sufficient for operating. The usage of a single switch control line has further the advantage that indefinite (i.e. undetermined) switching states are impossible.

Referring back to the low loss mode, the RF signal received by the antenna ANT is passed directly to the first transceiver 300. Correspondingly, the switch SwB is switched to connect port 1 with port 2 and the switch SwD is switched to connect port 2 and port 1 such that a direct electrical connection is established between the antenna ANT and the first transceiver 300 bypassing the RF signal divider DIV. Degradations along the established connection is minimal and depends only on the quality of the electrical properties of the switches and the printed wired board layout.

Referring back to high loss mode operation, the RF signal received by the antenna ANT is passed to the first transceiver 300 and the second transceiver 350 simultaneously. Correspondingly, the switch SwB is switched to connect port 1 and port 3 and the switch SwD is switched to connect port 3 and port 1. The RF signal provided by the antenna ANT is passed via the switch SwB to the RF signal divider DIV which supplies the RF signal further to the second transceiver 350 and via the switch SwD to the first transceiver 300. Due to the electrical properties of the RF signal divider DIV significant degradation of the resulting RF signals provided on the ports 2 and 3 cannot be avoided.

The illustrated antenna coupling circuit 100 shown in FIG. 1 may be improved advantageously by implementing a RF production test interface connector (not shown). The interface connector may be interposed between the antenna ANT and the switch SwB. The interface connector is employed for measuring, testing and tuning of the both the first transceiver 300 and the second transceiver 350. The RF production test interface connector should be combined with a further switch to disconnect the antenna ANT during testing and tuning.

The switching states of the switches SwB and SwD may be controlled by a dedicated switch controller which may be implemented in the antenna coupling circuit 100 (illustrated as controller CTRL in FIG. 1) or which may be realized as a separate switch controller (not shown in FIG. 1). The received signal strength indicator (RSSI) is supplied to the controller CTRL and the controller CTRL operates the switch states of the switches SwB and SwD via corresponding switch control lines in accordance with the supplied received signal strength indicator (RSSI). In low loss mode and high loss mode, respectively, the controller CTRL controls the switches SwB and SwD in accordance with the aforementioned switching states in the modes.

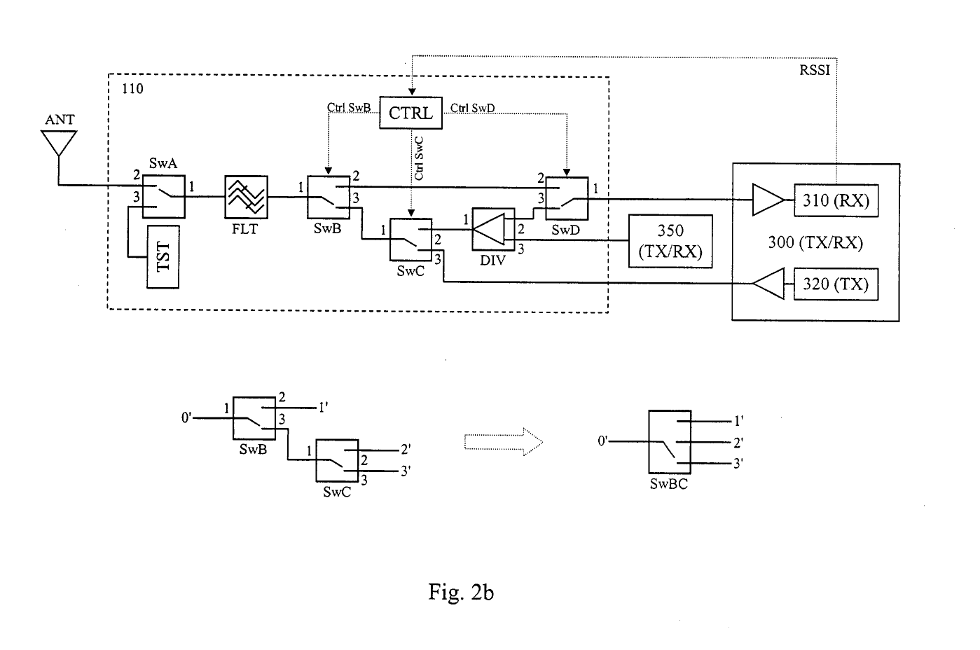

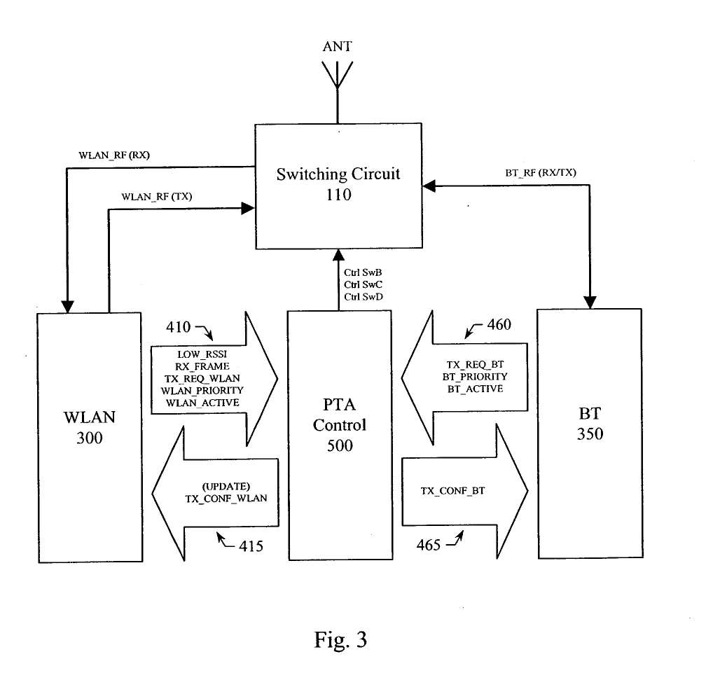

The following description in conjunction with the FIG. 2a FIG. 2b and FIG. 3 will be explained with reference to a WLAN transceiver as the first transceiver and a Bluetooth transceiver as the second transceiver. The description with respect to the WLAN and Bluetooth transceiver shall be understood as an example embodiment according to the present invention but not limited thereto.

FIG. 2a shows a table illustrating operation modes of an antenna coupling circuit according to an embodiment of the invention. The depicted operation modes represent operation modes which may be realized by an embodiment of the antenna coupling circuit according to the present invention. A corresponding embodiment of the antenna coupling circuit allowing to realized the operation modes illustrated in FIG. 2a is shown in FIG. 2b. The depicted switching states designates the port connection of switches SwB, SwC and SwD being components of the antenna coupling circuit shown in FIG. 2b. The modes 1 and 2 relate to a simultaneous operation of the both transceivers, i.e. the simultaneous operation of a WLAN transceiver and a Bluetooth transceiver. The operation modes 3 to 6 relate to single operation modes of one of the both transceivers, i.e. single operation of either the WLAN transceiver or the Bluetooth transceiver.

In detail mode 1 is equal to the low loss mode described above. The mode 1 allows to operate the WLAN transceiver as well as the Bluetooth transceiver in a receiving operation mode with the common antenna. Due to the simultaneous operation of both transceivers by the means of a RF signal divider, degradation of the RF signals results from the providing of the RF signals to both transceivers.

In detail mode 2 allows to operate the WLAN transceiver in receiving operation mode whereas the Bluetooth transceiver is allowed to operate in transmitting operation mode. The RF signals supplied by the common antenna and the RF signals generated by the Bluetooth transceiver during transmission are combined by the means of the RF signal divider such that degradation of the RF signal has to be conceded.

In detail mode 3 and 4 allow to operate the WLAN transceiver in receiving operation mode (mode 3) and transmitting operation mode (mode 4) exclusively with the common antenna. The Bluetooth transceiver is de-connected from the common antenna during these modes 3 and 4. Mode 3 corresponds to the aforementioned low loss mode. The single operation modes 3 and 4 of the WLAN transceiver are embodied in such a way that degradation of RF signals is minimized during receiving and transmitting of the WLAN transceiver, respectively.

In detail mode 5 and 6 allow to operate the Bluetooth transceiver in receiving operation mode (mode 5) and in transmitting operation mode (mode 6) exclusively with the common antenna. The WLAN transceiver is de-connected from the common antenna during these modes 5 and 6. The single operation modes 5 and 6 of the Bluetooth transceiver are embodied in such a way that degradation of RF signals is minimized during receiving and transmitting of the Bluetooth transceiver, respectively.

FIG. 2b shows a second antenna coupling system comprising an antenna ANT, a first transceiver 300, a second transceiver 350 and an antenna coupling circuit 110 according to an embodiment of the invention. The first transceiver 300 is embodied as separate receiving unit 310 and transmitting unit 320. The separation of the first transceiver 300 into a receiving unit 310 and a transmitting unit 320 has been carried out to present a more intellectual depiction of the antenna coupling circuit 110. The antenna coupling circuit 110 couples selectively the common antenna ANT to the transceivers and allows to realize the operation modes presented with reference to FIG. 2a.

The antenna coupling circuit 110 comprises switches SwA, SwB, SwC and SwD, a RF production test interface connector TST, a RF filter FLT, a RF signal divider DIV. Each switch SwA, SwB, SwC and SwD has three ports 1, 2 and 3 and has two switching states. In one switching state, port 1 and port 2 of the switch SwA, SwB, SwC and SwD are connected, respectively, whereas port 3 is disconnected. In the other switching state, port 1 and port 3 of the switches SwA, SwB, SwC and SwD are connected, respectively, whereas port 2 is disconnected. The switches SwB, SwC and SwD are electrically controlled switches, i.e. the switching states of the switches SwB, SwC and SwD is controlled by a switching state signal supplied to the switches SwB, SwC and SwD via a switching control line. A further advantages of switches being controlled by switching state control signal via single switching control lines is that a default switching state control signal provided on the switching control lines ensure an appropriate switching state of the switches even in power down or stand-by mode of the device comprising the antenna coupling circuit 110. The switches SwB, SwC and SwD may be embodied as state of the art, low implementation loss, radio frequency semiconductor switches each controlled via a single switching control line. The RF semiconductor switches should be adapted to the frequency band(s) which are employed by the transceivers 300 and 350 which are coupled to the antenna coupling circuit 1 10. The adapting of the RF semiconductor switches to the operation frequency band(s) of the transceivers guarantees that RF signal degradation due to the passing of the RF signal through the switches is minimized.

The RF. signal divider DIV may be embodied as a passive ceramic power divider which shall also be adapted to the frequency band(s) of the transceivers. State of the art passive ceramic power dividers causes signal losses when RF signals are passed from an input port to one or more output ports. That means, the losses due to the RF signal divider DIV depend on the impedance connected to the input and output ports. In normal power divider mode of a passive ceramic power divider component having an input port and two output ports, RF signals supplied to an input port undergo an unavoidable 3 dB signal loss and additional implementation loss when both output ports are connected to matching (typically 50 ohms) impedance components. This normal power divider mode is operated by the RF signal divider DIV in the simultaneous high loss operation mode of the antenna coupling circuit 110. In direct power feed through mode of a passive ceramic power divider component having an input port and two output ports, RF signals supplied to an input port undergo a significantly smaller signal loss than 3 dB of normal power divider mode when one of the output ports is connected to high impedance, i.e. is disconnected from any component for example by an open switch. This direct power feed through mode is operated by the RF signal divider DIV in single low loss operation modes of the antenna coupling circuit 110.

The filter FLT may be embodied as a passive ceramic band filter which shall be adapted to the frequency band(s) of the transceivers in order to pass though only frequencies dedicated to the transceivers.

In detail, the switch SwA is coupled to the antenna ANT via port 1 and is connected to the interface connector TST via port 3. The switch SwA allows to connect selectively either antenna ANT or interface connector TST to the antenna coupling circuit. The switch SwA is connected via port 1 to port 1 of the switch SwB. In turn, the switch SwB is connected via port 2 to port 2 of the switch SwD and via port 3 to port 1 of the switch SwC. The switch SwC is coupled via port 3 to the transmitting unit 320 of the first transceiver 300 and is connected via port 2 to port 1 of the RF signal divider which in turn is connected to port 2 of the switch SwD and is coupled via port 3 to the second transceiver 350. Port 1 of the switch SwD is coupled to the transmitting unit 310 of the first transceiver 300. Further the filter FLT may be interposed between port 1 of the switch SwA and port 1 of the switch SwB.

Alternatively, the switch SwC may be interposed between switch SwA and switch SwB which allows to switch also RF signals provided by the transmitting unit 320 of the first transceiver 300 to the antenna ANT and the interface connector TST, respectively. Moreover, the switches SwB and SwC may be combined to a 1-to-3 matrix switch. The substituting of the switches SwB and SwC to a combined switch SwBC is illustrated additionally in FIG. 2b. Both the switch arrangement comprising switches SwB and SwC and the matrix switch SwBC allow to connect selectively port 0′to port 1′, 2′and 3′, respectively, and vice versa.

The switch SwA may be a mechanically operated switch, i.e. the switch SwA is operable with the interface connector TST. For example, a mating half connector is attached into an integrated RF production test interface connector TST and switch SwA and turns automatically the switch SwA into a switching position disconnecting antenna ANT from the antenna coupling circuit and connecting the interface connector TST thereto. That means, the switch SwA is turned from the switching state, in which port 1 and port 2 are connected and antenna ANT is coupled in, to the switching state, in which port 1 and port 3 are connected and interface connector TST is coupled in.

Referring back to FIG. 2a the introduced operation modes 1 to 6 will now be described in detail in conjunction with the antenna coupling circuit 110 shown in FIG. 2b. For describing the switching states of the antenna coupling circuit 110 the transceivers 300 and 350 which are coupled thereto shall be identified just for example illustration as a WLAN receiving unit 310 of a WLAN transceiver 300, a WLAN transmitting unit 320 of the WLAN transceiver 300 and a Bluetooth transceiver 350. The following sections refer to an antenna operation modes of the antenna coupling circuit 110, i.e. the switch SwA is set to connect ports 2 and 1 to pass through RF signals supplied by the antenna A to port 1 of the switch SwB. The RF signals may have to pass the filter FLT interposed between switch SwA and switch SwB. A description of testing modes implying an operating of the switch SwA will follow the description of the antenna operation modes.

In mode 1 simultaneous operation of the WLAN transceiver 300 and the Bluetooth transceiver 350 both in receiving operation mode shall be allowed. Correspondingly, as shown additionally in FIG. 2a the switch SwB is set to connect ports 1 and 3, the switch SwC is set to connect ports 1 and 2 and the switch SwD is set to connect ports 1 and 3. RF signals received by the antenna ANT and supplied to the antenna coupling circuit 110 are passed through the switches SwB and SwC, RF signal divider DIV and are supplied to the Bluetooth transceiver 350 and to the WLAN receiving unit 310 of the WLAN transceiver 300 via the switch SwD, respectively. Due to the passing of the RF signals through the RF signal divider DIV which is connected to the Bluetooth transceiver 350 and the WLAN receiving unit 310 the RF signals are attenuated by the unavoidable 3 dB loss of the passive power divider and additional implementation loss of the passive power divider and the switches. Hence, the simultaneous receiving operation mode is a high loss operation mode.

In mode 2 simultaneous operation of the WLAN transceiver 300 in receiving operation mode and the Bluetooth transceiver 350 in transmitting operation mode shall be allowed. Correspondingly, as shown additionally in FIG. 2a, the switch SwB is set to connect ports 1 and 3, the switch SwC is set to connect ports 1 and 2 and the switch SwD is set to connect ports 1 and 3. RF signals received by the antenna ANT and supplied to the antenna coupling circuit 110 are passed through the switches SwB and SwC, RF signal divider DIV, the switch SwC and are. supplied to the WLAN receiving unit 310 of the WLAN transceiver 300. RF signals generated by the Bluetooth transceiver 350 to be transmitted via the antenna ANT are supplied to the RF signal divider DIV to be passed on to the switch SwB and via the filter FLT and the switch SwA to the antenna ANT. Due to the passing of the RF signals through the RF signal divider DIV which is connected to the Bluetooth transceiver 350 and the WLAN receiving unit 310 the RF signals are attenuated by the unavoidable 3 dB loss of the passive power divider and the additional loss of the passive power divider and the switches. Hence, the simultaneous receiving/transmitting operation mode is a high loss operation mode. Interference may occur due to the mixing of the RF signals received by the antenna ANT and the RF signal generated by the Bluetooth transceiver 350. This kind of signal interference is known as internal interference and will be discussed with reference to FIG. 3.

In mode 3 single operation of the WLAN transceiver 300 in receiving mode shall be allowed. Correspondingly, as shown additionally in FIG. 2a the switch SwB is set to connect ports 1 and 2 and the switch SwD is set to connect ports 1 and 2. RF signals received by the antenna ANT and supplied to the antenna coupling circuit 110 are passed through the switch SwB and the switch SwD to be supplied to the WLAN receiving unit 310 of the WLAN transceiver 300. The switching state of the switch SwC may be arbitrary. The RF signals bypasses the RF signal divider DIV and the Bluetooth transceiver 350 is disconnected completely from the antenna ANT. Hence, the single WLAN receiving operation mode is a low loss operation mode.

In mode 4 single operation of the WLAN transceiver 300 in transmitting mode shall be allowed. Correspondingly, as shown additionally in FIG. 2a the switch SwC is set to connect ports 1 and 3 and the switch SwB is set to connect ports 1 and 3. RF signals generated by the WLAN transmitting unit 320 of the WLAN transceiver 300 are supplied to the switch SwC and switch SwB, the filter FLT and the switch SwA to the antenna ANT to be transmitted. The switching state of the switch SwD may be arbitrary. The RF signals bypasses the RF signal divider DIV and the Bluetooth transceiver 350 is disconnected completely from the antenna ANT. Hence, the single WLAN transmitting operation mode is a low loss operation mode.

In mode 5 and 6 single operation of the Bluetooth transceiver 350 in receiving and transmitting mode shall be allowed, respectively. Correspondingly, as shown additionally in FIG. 2a in mode 5 and 6 the switch SwB is set to connect ports 1 and 3, the switch SwC is set to connect ports 1 and 2 and the switch SwD is set to connect ports 1 and 2. In mode 5, RF signals received by the antenna ANT and supplied to the antenna coupling circuit 110 are passed through the switches SwB and SwC to the RF signal divider DIV which supplies the RF signals to the Bluetooth transceiver 350. In mode 6, RF signals generated by the Bluetooth transceiver 350 are supplied to the RF signal divider DIV and passed through the switches SwC, SwB, the filter FLT and the switch SwA to the antenna ANT to be transmitted. In both modes 5 and 6 the switch SwD is set to connect ports 1 and 2, i.e. the RF signal divider DIV is operated in the direct power feed through mode such that RF signals (in receiving operation mode and in transmitting operation mode) which are fed through undergo a significantly smaller signal loss than 3 dB loss of normal power divider mode. Hence, the single Bluetooth receiving and transmitting operation modes are low loss operation modes, respectively.

In testing modes, a mating half connector is attached to the RF production test interface connector TST. In parallel, the switch SwA is set to connect ports 1 and 3 to connect the interface connector TST to the antenna coupling circuit 110 instead of the antenna ANT. The testing mode allows to test, measure and tune the transceivers 300 and 350 which are coupled to the antenna coupling circuit 110. In a WLAN transmission testing mode, RF signals generated by the WLAN transmitting unit 320 of the WLAN transceiver 300 are passed through the switches SwC, SwB, the filter FLT and the switch SwA to the interface connector TST. The switch SwC is set to connect ports 1 and 3 and the switch SwB is set to connect ports 1 and 3. In a WLAN reception testing mode, RF signals supplied via the interface connector TST are passed via the switches SwB and SwD to the WLAN receiving unit 310 of the WLAN transceiver 300. The switch SwB is set to connect ports 1 and 2 and the switch SwD is set to connect ports 1 and 2. In a Bluetooth transmission and reception mode, RF signals are passed through switches SwB, SwC and RF signal divider DIV to the Bluetooth transceiver 350. The switch SwB is set to connect ports 1 and 3 and the switch SwC is set to connect ports 1 and 2. In case the switch SwD is set to connect ports 1 and 2 the Bluetooth transceiver 350 may be tested, measured and tuned with a significantly smaller signal loss than 3 db loss of normal power divider mode when the RF signal divider is operated in direct power feed through mode. In case the switch SwD is set to connect ports 1 and 3 the Bluetooth transceiver 350 may be tested, measured and tuned with an unavoidable 3 dB signal loss and additional implementation loss which is among other caused by the RF signal divider which is operated in normal power divider mode.

The switching states of the switches SwB, SwC and SwD may be controlled by a dedicated switch controller which may be implemented in the antenna coupling circuit 110 (illustrated as controller CTRL in FIG. 2b), which may be realized as a separate switch controller (not shown in FIG. 2b) or which may be integrated into one of the transceivers 300 and 350, respectively (not shown in FIG. 2b). The received signal strength indicator (RSSI) of the receiving unit 310 of the WLAN transceiver 300 is supplied to the controller CTRL and the controller CTRL operates the switch states of the switches SwB, SwC and SwD via corresponding switch control lines in accordance with the supplied received signal strength indicator (RSSI) and other signals (not shown in FIG. 2b) from the transceivers 300 and 350 which among others indicate operation modes of each transceivers 300 and 350 such as transmission operation, reception operation, idle mode operation etc. (refer to embodiment shown in FIG. 3). In low loss mode and high loss mode, respectively, the controller CTRL controls the switches SwB, SwC and SwD in accordance with the aforementioned switching states in the modes.

The quality signal or the received signal strength indicator (RSSI), respectively, reflects the signal quality of RF signals received by the WLAN receiving unit 310 of the WLAN transceiver 300. The received signal strength indicator (RSSI) represents a measure and quantity reflecting the strength of the useful radio signal above the RF signal background noise (RF noise). More precisely, the received signal strength indicator (RSSI) represents an indication signal which relates to the an signal power level. The determination of the received signal strength indicator (RSSI) may be based on a measurement of a power level of the received radio frequency signals, a determination of a signal-to-noise ratio (SNR) of the received radio frequency signals or may be based on any analogous determination method. . The power level and the signal-to-noise ratio should be obtained within a frequency range of interest, i.e. the frequency range or operation frequencies of the WLAN transceiver 300 and the WLAN receiving unit 310 of the WLAN transceiver 300, respectively. The radio frequency signals which are received by the transceiver, such as the WLAN receiving unit 310 of the WLAN transceiver 300, have to show a sufficient signal-to-noise ratio (SNR) or the received signal strength indicator (RSSI) value, respectively, such that an analyzing and evaluating of the received radio frequency signals lead to useful reception of the communications which is based on the conveyed radio frequency signals. The evaluation of the received signal strength indicator (RSSI) may be performed by comparing the received signal strength indicator (RSSI) with a predefined threshold value, such that in case the received signal strength indicator (RSSI) is smaller than the pre-defined threshold value the operation mode of the antenna coupling circuit 110 is switched to a low loss mode whereas in case the received signal strength indicator (RSSI) is greater than the pre-defined threshold value the operation mode of the antenna coupling circuit 110 is switched to a high loss mode.

It shall be noted that the antenna ANT may be realized in a broad number of ways including different printed wired board structures, PIFA structures and the like. An exact realization of the antenna is outside of the scope of the present invention. Analogously, the exact realization and implementation of the switches, divider, filters and/or connectors required for implementing an embodiment of the antenna coupling circuit is also outside of the scope of the present invention. The application of an antenna coupling circuit for operating a WLAN transceiver and a Bluetooth transceiver with a common single antenna is only one of a broad number of transceiver combinations cover by the scope of the invention.

The combined operation of a WLAN transceiver and a Bluetooth transceiver with a common antenna by the means of an antenna coupling circuit according to an embodiment of the invention as introduced above shall be completed with further issues relating to this special transceiver combination but without limiting the present invention thereto.

The coexistence of WLAN and Bluetooth transceivers in a multi-modal terminal are subjected to interference due to the fact that WLAN according to the 802.11b standard and Bluetooth are both operated in the ISM (industrial, scientific and medical) frequency band at approximately 2.4 GHz. This ISM frequency band is worldwide free of any radio frequency licenses. Two types of interference are distinguished, the external interference and the internal interference. External interference is caused by other Bluetooth and WLAN transceivers operating in the near vicinity of the victim transceiver. Internal interference is caused by transceivers operating in the same terminal on the same frequency band. An appropriate Bluetooth and WLAN coexistence scheme must have means to mitigate both external and internal interference. One target requirement is to enable use of Bluetooth at usable quality at the same time as WLAN data transfer at reduced but sufficient data transmission rates.

Coexistence framework has been studied in IEEE802.15.2 Recommended Practice Task Group. One of the mitigation schemes discussed in IEEE802.15.2 is Packet traffic arbitration (PTA) scheme where Bluetooth transceiver and WLAN transceiver exchange information in real-time.

FIG. 3 shows a third antenna coupling system comprising an antenna ANT, a WLAN transceiver 300, a Bluetooth transceiver 350, a packet traffic arbitration (PTA) controller 500 and an antenna coupling circuit 110 according to an embodiment of the invention.

The Bluetooth transceiver 350 signals its real time status to the PTA controller 500 using signals 460. The PTA controller can prevent the Bluetooth transceiver 350 from transmitting by de-asserting the control signal TX_CONF_BT (465). Real time WLAN status information is available inside the WLAN chipset are also signalized as signals 410 to the PTA controller 500. Examples of possible information are available in the IEEE802.15.2 Recommended Practice.

Additional non-real time status information may be supplied to PTA controller 500. This information includes, but is not limited to, current WLAN channel and current WLAN operation mode (idle, best-effort traffic, quality of service, etc.), Bluetooth operation mode (idle, (enhanced) synchronous connection oriented link (SCO), asynchronous connectionless link (ACL), etc.), Bluetooth 1.2 adaptive frequency hopping (AFH) hop set, etc.

Especially, the adaptive frequency hopping (AFH) which will be part of the coming Bluetooth 1.2 standard allows a Bluetooth transceiver such as the Bluetooth transceiver 350 to reduce the number of channels it hops across, leaving some channels open for other devices, in particular the WLAN transceiver 300. Without adaptive frequency hopping (AFH), Bluetooth transceivers hops across 79 of the available 83.5 channels in the 2.4 GHz ISM frequency band for transceiving to minimize interference and maximize transmission quality. In conjunction with adaptive frequency hopping (AFH) Bluetooth transceivers should be able to reduce the number and selection of channels for hopping to around 15 channels, leaving up to 68 free. The adaptive frequency hopping (AFH) should offer a sensible solution for transceivers coming in and out of interference range of one another. In view of the present invention, adaptive frequency hopping (AFH) supports the applicability of the antenna coupling system which allows to simultaneously connect both the Bluetooth transceiver 350 and the WLAN transceiver 300 to the common antenna for simultaneously receiving in accordance with the aforementioned (high loss) mode 1, and for simultaneously transmitting and receiving in accordance with the aforementioned (high loss) mode 2.

The PTA controller 500 makes decisions to cancel Bluetooth or WLAN transmissions based on the available information. It is recommended that outgoing best effort WLAN data has the lowest priority, and WLAN acknowledgement frames have priority over all Bluetooth traffic. These and other priorities and implementation of the PTA controller 500 are implementation details.

The PTA controller 500 can be employed in a modification to control the switching states of switches in an antenna coupling circuit 110 according to an embodiment of the present invention.

WLAN 802.11b packet structure is such that a low data rate preamble and header always precedes the actual possibly higher data rate payload. Due to the data rate difference between header and payload parts of the WLAN packet structure the signal-to-noise ratio (SNR) of the received signal is also required for successfully receiving the packet is different for header and payload. This detail of packet structure can be used as an advantage in the antenna sharing scenario described above in conjunction with embodiments of the antenna coupling circuit of the present invention. It may be assumed that both WLAN transceiver 300 and Bluetooth transceiver 350 are active (not in idle mode) and are both waiting for incoming packets with the antenna coupling circuit 110 operating in simultaneous WLAN and Bluetooth receiving operation mode (corresponding to the high loss mode 1 shown in FIG. 2a). In case a WLAN packet starts to come in (RF signal WLAN_RF (RX)) the preamble is received and detected by WLAN receiving unit 310 of the WLAN transceiver 300 and received signal strength indicator (RSSI) and the signal-to-noise ratio (SNR) of the preamble is measured, respectively. The header is decoded with information about the data rate of payload and information that the following payload is targeted for the WLAN transceiver 300. If simultaneously no Bluetooth traffic is being received and it is likely that no traffic will be available for the duration of the incoming WLAN packet, the operation mode of the antenna coupling circuit can be switched to the single WLAN receiving operation mode (corresponding to low loss mode 3) for the duration of the WLAN packet reception in case the determined RSSI and SNR value of the received preamble indicate, respectively, that an operation with high loss mode does not support any reliable reception. With this arrangement it is possible to monitor both WLAN and Bluetooth traffic simultaneously with no user detectable performance degradation in the WLAN receiving sensitivity, provided that the difference between data rate of header and- payload with corresponding difference in the required received signal strength indicator (RSSI) is big enough. Typically maximum 11 Mbits/s payload data rate is used with 1 Mbits/s header data rate. This causes a difference of 7 to 9 dB in required received signal strength indicator (RSSI) and signal-to-noise ratio (SNR), respectively, which is significantly larger than a RF signal difference in WLAN reception loss between single WLAN receiving operation mode (low loss mode 3) and simultaneous WLAN and Bluetooth receiving operation mode (high loss mode 1). Difference of loss between combination of implementation loss of switches (low loss mode 3) and the combination of the unavoidable 3 db signal loss in the power divider, implementation loss of the passive power divider and implementation loss of switches (high loss mode 1) is typically higher than 3 db . During the period of time the antenna coupling circuit 110 is operated in the single WLAN receiving operation mode it may be possible to miss incoming Bluetooth packets. This effect can be prevented or at least minimized when the received signal strength indicator (RSSI) of the incoming WLAN packet in the simultaneous WLAN and Bluetooth receiving mode is compared against a pre-defined threshold value before switching to the single WLAN receiving mode. In case the RSSI of incoming WLAN packet is high (compared with the pre-defined threshold value) it is likely that payload can be received correctly even without changing to the single WLAN receiving mode. In case the RSSI is low (compared with the pre-defined threshold value) it is likely, that payload will not be received correctly without changing to the single WLAN receiving operation mode of the antenna coupling circuit 110.

The received signal strength indicator (RSSI) and signal-to-noise ratio (SNR) of the incoming WLAN frame is known early at the start of the reception of the preamble. For example, the duration of the preamble in accordance with the WLAN 802.11b standard is selected so that real-time switched antenna diversity can be implemented, giving enough time for multiple automatic gain control (AGC) setting. In case the received signal strength indicator (RSSI) and signal-to-noise ratio (SNR) is good enough for reception of all data rates, the mode of the antenna coupling circuit 110 can be kept in a high loss mode such as mode 1. In case the signal-to-noise ratio (SNR) is not good enough, the mode of the antenna coupling circuit 110 can be changed to a low loss mode such as mode 3 in case no high-priority Bluetooth reception is expected to happen during the reception of the WLAN frame.

In case the mode of the antenna coupling circuit 110 is changed either from low-loss to high-loss or from high-loss to low-loss the WLAN radio may need to adjust the automatic gain control. For orthogonal frequency division multiplex (OFDM) modes of the WLAN 802.11g standard the preamble is much shorter and the timing requirements are more stringent. The mode change of the antenna coupling circuit 110 has to be adapted to the timing requirements such that mode change is operable during reception of the preamble.

Possible signaling scheme example is shown in FIG. 3. From the invention point of view, it is critical that the system includes signaling from the WLAN transceiver 300 to the PTA controller 500, which allows the PTA controller 500 to determine that the WLAN has detected a frame on the radio frequency channel (RX_FRAME, 410) and to detect the quality of the received signals (LOW_RSSI (410) which is a logical signal resulting from the comparison of the received signal strength indicator (RSSI) with the pre-defined threshold value). Based on this information and other BluetoothWLAN coexistence information the PTA controller 500 operates the mode change of the antenna coupling circuit 110 via the switching state control signals Crtl SwB, Crtl SwC and Crtl SwD.

Lower part of the signaling (TX—REQ_WLAN, WLAN_PRIORITY, WLAN_ACTIVE, 410; TX_CONF_WLAN, 415) are typical WLAN-Bluetooth coexistence signals operated in the same fashion as the corresponding Bluetooth signals, and to some extent can be considered prior art. Based on the signals (from Bluetooth and from WLAN) and auxiliary (non-real time) information, the PTA controller 500 prioritizes Bluetooth and WLAN transmissions (TX_CONF_BT, 465 and TX_CONF_WLAN, 415, respectively).

It will be obvious for those skilled in the art that as the technology advances, the inventive concept can be implemented in a broad number of ways. The invention and its embodiments are thus not limited to the examples described above but may vary within the scope of the claims.

1. An antenna coupling system for operating an antenna (ANT) with a first transceiver (300) and a second transceiver (350),
wherein said first transceiver (300) provides a quality signal (RSSI) relating to a received radio frequency signal, which is supplied to said antenna coupling system (100, 110),
wherein said antenna coupling system (100, 110) is operable with at least a low loss mode and a high loss mode in accordance with said quality signal (RSSI),
wherein said antenna coupling system (100, 110)
selectively connects one of said first and second transceivers (300, 350) to said antenna (ANT) in said low loss mode, wherein another one of said transceivers is disconnected; and
simultaneously connects said first transceiver (300) to said antenna (ANT) and said second transceiver (350) to said antenna (ANT) in said high loss mode.

2. The system according to claim 1, comprising a first switch (SwB), a second switch (SwD) and a signal divider (DIV), wherein
said first switch (SwB) is connected to said antenna (ANT), said second switch (SwD) and said signal divider (DIV);
said second switch (SwD) is connected to said first switch (SwB), said signal divider (DIV) and said first transceiver (300); and
said signal divider (DIV) is connected to said first switch (SwB), said second switch (SwD) and said second transceiver (350).

3. The system according to claim 2, further comprising a third switch (SwC),
wherein said first transceiver (300) includes a transmitting unit (320) and a receiving unit (310), wherein
said second switch (SwD) is connected to said receiving unit (310); and
said third switch (SwC) is interposed between said antenna (ANT) and said signal divider (DIV) to connect selectively said transmitting unit (320) to said antenna (ANT).

4. The system according to claim 3, wherein said antenna coupling system (100, 110) operable with said high loss mode is further operable with a first mode (mode 1) and a second mode (mode 2), and said antenna coupling system (100, 110) operable with said low loss mode is further operable with a third mode (mode 3), a fourth mode (mode 4), a fifth mode (mode 5) and a sixth mode (mode 6),
wherein said antenna coupling system (100, 110) couples simultaneously said receiving unit (310) and said second transceiver (350) to said antenna (ANT),
for simultaneous receiving by said receiving unit (310) and said second transceiver (350) in said first mode (mode 1); and
for simultaneous receiving by said receiving unit (310) and simultaneous transmitting by said second transceiver (350) in said second mode (mode 2); wherein said antenna coupling system (100, 110) couples exclusively said first transceiver (300) to said antenna (ANT)
for exclusive receiving by said receiving unit (310) in said third mode (mode 3); and
for exclusive transmitting by said first transmitting unit (320) in said fourth mode (mode 4);
wherein said antenna coupling system (100, 110) couples exclusively said second transceiver (350) to said antenna (ANT):
for exclusive receiving by said second transceiver (350) in said fifth mode (mode 5); and
for exclusive transmitting by said second transceiver (350) in said sixth mode (mode 6).

5. The system according to claim 4, further comprising a testing interface (TST) and a fourth switch (SwA) for operating testing modes, wherein said antenna coupling system (100, 110) connects selectively said testing interface (TST) to said receiving unit (310) in a first testing mode, to said transmitting unit (320) in a second testing mode and to said second transceiver (350) in a third testing mode.

6. The system according to claim 4, wherein said first transceiver (300) and said second transceiver (350) operate in a same frequency range for transceiving RF signals.

7. The system according to claim 6, wherein said first transceiver (300) operates in a frequency sub-range of said same frequency range for receiving in said second mode (mode 2) and said second transceiver (350) operates in at least another frequency sub-range of said same frequency range for transmitting in said second mode (mode 2).

8. A method for operating an antenna coupling system (100, 110) for controlling an operation of an antenna (ANT) in conjunction with a first transceiver (300) and a second transceiver (350),
receiving a quality signal (RSSI) from said first transceiver (300), wherein said quality signal (RSSI) relates to a received radio frequency signal;
in accordance with said quality signal (RSSI), selecting an operation mode from modes including at least a low loss mode and a high loss mode;
operating said antenna coupling system with said selected operation mode by
selectively connecting one of said first and second transceivers (300, 350) to said antenna (ANT) while disconnecting another one of said transceivers in said low loss mode; and
simultaneously connecting said first transceiver (300) and said second transceiver (350) to said antenna (ANT) in said high loss mode.

9. The method according to claim 8, wherein said selecting of said operation mode comprises:
comparing said quality signal (RSSI) with a pre-defined threshold value to select said operation mode from modes including at least said low loss mode and said high loss mode.

10. The method according to claim 8, wherein said antenna coupling system (100, 110) comprises a first switch (SwB), a second switch (SwD) and a signal divider (DIV),
wherein said operating of said antenna coupling system (100, 110) with said low loss mode comprises:
operating said switches (SwB, SwD) to establish a signal path between said antenna (ANT) and said one of said first and second transceivers (300, 350), wherein said other one of said transceivers is disconnected;
wherein said operating of said antenna coupling system (100, 110) with said high loss mode comprises:
operating said switches (SwB, SwD) to establish a first signal path between said antenna (ANT) and said first transceiver (300) and to establish simultaneously a second signal path between said antenna (ANT) and said second transceiver (350).

11. The method according to claim 10, wherein said antenna coupling system (100, 110) further comprises a third switch (SwC) and said first transceiver (300) includes a transmitting unit (320) and a receiving unit (310), wherein said high loss mode further includes a first mode (mode 1) and a second mode (mode 2) and said low loss mode further includes a third mode (mode 3), a fourth mode (mode 4), a fifth mode (mode 5), a sixth mode (mode 6);
wherein said operating of said antenna coupling system (100, 110) with said first mode (mode 1) and said second mode (mode 2) comprises:
operating said switches (SwB, SwD, SwC) to establish a first signal path between said antenna (ANT) and said receiving unit (310) for receiving and to establish simultaneously a second signal path between said antenna (ANT) and said second transceiver (350) for receiving and transmitting;
wherein said operating of said antenna coupling system (100, 110) with said third mode (mode 3) comprises:
operating said switches (SwB, SwD, SwC) to establish a signal path between said antenna (ANT) and said receiving unit (310) for receiving, wherein said second transceiver (350) is disconnected;
wherein said operating of said antenna coupling system (100, 110) with said fourth mode (mode 4) comprises:
operating said switches (SwB, SwD, SwC) to establish a signal path between said antenna (ANT) and said transmitting unit (320) for transmitting, wherein said second transceiver (350) is disconnected;
wherein said operating of said antenna coupling system with said fifth mode (mode 5) and said sixth mode (mode 6) comprises:
operating said switches (SwB, SwD, SwC) to establish a signal path between said antenna (ANT) and said second transceiver (350) for receiving and transmitting, wherein said first transceiver (300) is disconnected.

12. The method according to claim 11, wherein said antenna coupling system (100, 110) comprises a testing interface (TST) and a fourth switch (SwA) and is operable with testing modes,
wherein said operating of said antenna coupling system with a first testing mode comprises:
operating said switches (SwB, SwD, SwC) to establish a signal path between said testing interface (TST) and said receiving unit (310);
wherein said operating of said antenna coupling system with a second testing mode comprises:
operating said switches (SwB, SwD, SwC) to establish a signal path between said testing interface (TST) and said transmitting unit (320);
wherein said operating of said antenna coupling system with a third testing mode comprises:
operating said switches (SwB, SwD, SwC) to establish a signal path between said testing interface (TST) and said second transceiver (350);
wherein said antenna (ANT) is disconnected in said testing modes.

13. The method according to claim 8, wherein said first transceiver and said second transceiver are operable with substantially a same frequency band.

14. A controller for an antenna coupling system (100, 110) for operating an antenna (ANT) with a first transceiver (300) and a second transceiver (350),
wherein said controller (CTRL, 500) receives a quality signal (RSSI) from said first transceiver (300), which determines said quality signal (RSSI) from a received radio frequency signal
wherein said controller (CTRL, 500) generates at least one control signal at least on the basis of said quality signal (RSSI), wherein said at least one control signal is supplied to the antenna coupling system (100, 110) such that said antenna coupling system (100, 110) is operable with at least a low loss mode and a high loss mode,
wherein said antenna coupling system (100, 110) connects
selectively said one of said first and second transceivers (300, 350) to said antenna (ANT) in said low loss mode, wherein said other transceiver is disconnected; and
simultaneously said first transceiver (300) to said antenna (ANT) and said second transceiver (350) to said antenna (ANT) in said at least one high loss mode.

15. The controller according to claim 14, wherein said controller controls an antenna coupling system (100, 110) which operates an antenna (ANT) with said first transceiver (300) which includes a transmitting unit (320) and a receiving unit (310) and said second transceiver (350);
wherein said controller (CTRL, 500) generates at least one control signal such that said antenna coupling system (100, 110) is operable with at least said high loss mode which further includes a first mode (mode 1) and a second mode (mode 2) and said low loss mode which further includes a third mode (mode 3), a fourth mode (mode 4), a fifth mode (mode 5), a sixth mode (mode 6)
wherein said antenna coupling system (100, 110) couples simultaneously said receiving unit (310) and said second transceiver (350) to said antenna (ANT),
for simultaneous receiving by said receiving unit (310) and said second transceiver (350) in said first mode (mode 1); and
for simultaneous receiving by said receiving unit (310) and simultaneous transmitting by said second transceiver (350) in said second mode (mode 2);
wherein said antenna coupling system (100, 110) couples exclusively said first transceiver (300) to said antenna (ANT)
for exclusive receiving by said receiving unit (310) in said third mode (mode 3); and
for exclusive transmitting by said first transmitting unit (320) in said fourth mode (mode 4);
wherein said antenna coupling system (100, 110) couples exclusively said second transceiver (300) to said antenna (ANT):
for exclusive receiving by said second transceiver (300) in said fifth mode (mode 5); and
for exclusive transmitting by said second transceiver (300) in said sixth mode (mode 6).

16. A Software tool for operating an antenna coupling system, comprising program portions for carrying out the operations of claim 8, when said program is implemented in a computer program for being executed on a microprocessor based component, processing device, a terminal device, a communication terminal device or a network device.

17. A Computer program product for operating an antenna coupling system, comprising loadable program code sections for carrying out the operations of claim 8, when said program code is executed on a microprocessor based component, a processing device, a terminal device, a communication terminal device or a network device.

18. A Computer program product for operating an antenna coupling system, wherein said computer program product is comprising program code sections stored on a computer readable medium for carrying out the method of claim 8, when said computer program product is executed on a microprocessor based component, a processing device, a terminal device, a communication terminal device or a network device.

19. A Computer data signal embodied in a carrier wave and representing instructions which when executed by a processor cause the steps of claim 8 to be carried out.
